(19) United States
(12) Patent Application Publication
(10) Pub. No.: US 2025/0300544 A1
(43) Pub. Date: Sep. 25, 2025

(54) MULTI-TIERED MAGNETIC COUPLING IN A POWER CONVERTER

(71) Applicant: Infineon Technologies Austria AG, Villach (AT)

(72) Inventors: Roberto RIZZOLATTI, Villach (AT); Gerald J. Deboy, Klagenfurt (AT); Mario URSINO, Villach (AT)

(21) Appl. No.: 19/079,953

(22) Filed: Mar. 14, 2025

Related U.S. Application Data
(60) Provisional application No. 63/567,209, filed on Mar. 19, 2024.

(51) Int. Cl. H02M 1/00; H02M 1/14; H02M 3/156

(52) U.S. Cl. CPC H02M 1/007; H02M 1/143; H02M 3/156

(57) ABSTRACT

A multitiered power converter as discussed herein includes first power converter circuitry and second power converter circuitry. The first power converter circuitry is magnetically coupled to a first circuit path. The second power converter circuitry is magnetically coupled to a second circuit path. The multi-tiered power converter further includes a third circuit path. Each of the first circuit path and the second circuit path are magnetically coupled to the third circuit path to support conversion of at least one input voltage into at least one output voltage.

### RELATED APPLICATION

This application claims the benefit of earlier filed U.S. Patent Application Ser. No. 63/567,209 entitled “ELECTRIC COUPLED INDUCTOR FOR MULTI-STAGE DC-DC POWER SUPPLY SYSTEM,” (Attorney Docket No. 2024P04682US), filed on Mar. 19, 2024, the entire teachings of which are incorporated herein by this reference.

### BACKGROUND

There are multiple types of switching power converters. For example, one type of conventional switching power converter is a buck converter. In general, to maintain an output voltage within a desired range, a controller associated with the buck converter compares the magnitude of a generated output voltage to a setpoint reference voltage. Based on a respective error voltage from the comparison, the power converter controller modifies a respective switching frequency and/or pulse width modulation associated with activating high side switch circuitry or low side switch circuitry in the buck converter to maintain a magnitude of a respective output voltage.

Another type of power converter is a so-called Trans-Inductor Voltage Regulator (TLVR). In general, a TLVR includes multiple power converter phases, each of which includes a multi-winding transformer. A first winding of each power converter phase (such as a buck converter configuration) is connected in series, providing serial coupling amongst the multiple phases. A second winding of each phase contributes to producing a respective output voltage that powers a load.

Thus, a conventional TLVR (Trans-inductance Voltage Regulator) system is generally a voltage regulator (e.g. a buck converter) where the magnetic device is no longer a single-winding inductor, but a transformer with two windings; where the primary windings constitute the phase inductors. The secondary windings are the so called TLVR windings in series, which are used to improve the transient performance of supplying a respective output voltage to a load.

### BRIEF DESCRIPTION

This disclosure includes the observation that so-called conventional trans-inductance power converters as previously discussed may be limited in power density as well as transient performance due to a limitation in the maximum number of phases that can be coupled to each other in series. As discussed herein, a novel power converter solution may include a cascaded TLVR (a.k.a., Trans-Inductance Voltage Regulator) architecture, which overcomes the main limitations of conventional techniques. In one example, to address the deficiencies associated with conventional techniques of implementing a trans-inductance voltage regulator, techniques herein include implementing a multi-level trans-inductance power converter.

More specifically, the disclosure as discussed herein includes an apparatus comprising: first power converter circuitry magnetically coupled to a first circuit path; second power converter circuitry magnetically coupled to a second circuit path; and a third circuit path, wherein each of the first circuit path and the second circuit path are magnetically coupled to the third circuit path.

In one example, the first power converter circuitry includes a first winding, where the first winding is magnetically coupled to a second winding disposed in or, more specifically, in series in the first circuit path; the second power converter circuitry includes a third winding, where the third winding is magnetically coupled to a fourth winding disposed in or, more specifically, in series in the second circuit path.

In another example, the first power converter circuitry can be configured to include a first group of power converters, each of which is magnetically coupled to the first circuit path. The second power converter circuitry can be configured to include a second group of power converters, where each of which is magnetically coupled to the second circuit path. The apparatus may further include control circuitry or controller operative to control each of the power converters to provide balancing of output currents outputted from the power converters in the first group and the power converters in the second group to produce an output voltage.

In another example as discussed herein, the apparatus further includes a first power supply or power source operative to supply first current to the first circuit path at a first terminal of the first circuit path. The second terminal of the first circuit path can be configured to output the first current to produce an output voltage. The apparatus may further include a second power supply operative to supply second current to the second circuit path at a first terminal of the second circuit path. The second terminal of the second circuit path can be configured to output the second current to produce the output voltage.

Still further, the apparatus can be configured to include: a first transformer including a first winding magnetically coupled to a second winding, where the first winding is disposed in series in the first circuit path, and a second transformer including a third winding magnetically coupled to a fourth winding, where the third winding is disposed in series in the second circuit path. It is further noted that the second winding may be disposed in series with the fourth winding in the third circuit path.

Yet further, it is noted that the first power converter circuitry and the second power converter circuitry can be configured to operate in parallel to collectively produce an output voltage.

In a further example as discussed herein, the apparatus may further include: third power converter circuitry magnetically coupled to a fourth circuit path; fourth power converter circuitry magnetically coupled to a fifth circuit path; and a sixth circuit path, wherein each of the fourth circuit path and the fifth circuit path are magnetically coupled to the sixth circuit path. The apparatus may further include a seventh circuit path, where the third circuit path is magnetically coupled to the seventh circuit path, and where the sixth circuit path is magnetically coupled to the seventh circuit path.

The apparatus may further an output node operative to output an output voltage, where each of the first power converter circuitry, the second power converter circuitry, the third power converter circuitry, and the fourth power converter circuitry collectively contribute to producing an output voltage; and where each of the first circuit path, the second circuit path, the third circuit path, the fourth circuit path, the fifth circuit path, the sixth circuit path, and the seventh circuit path output respective output current to the output node to produce the output voltage.

In still further examples, the apparatus as discussed herein can be configured to include an output node operative to output an output voltage collectively generated by the first power converter circuitry and the second power converter circuitry. Each power converter in the first power converter circuitry can be configured to include a respective output terminal, where the respective output terminals of the power converters in the first power converter circuitry can be configured to collectively supply first output current to the output node. Each power converter in the second power converter circuitry can be configured to include a respective output terminal, where the respective output terminals of the power converters in the second power converter circuitry can be configured to collectively supply second output current to the output node.

In a further example, the first circuit path as discussed herein can be configured to include a terminal operative to supply third output current to the output node; the second circuit path can be configured to include a terminal operative to supply fourth output current to the output node. The third circuit path can be configured to include includes a terminal operative to supply fifth output current to the output node. A fourth circuit path of the apparatus may be magnetically coupled to the third circuit path, where the fourth circuit path includes a terminal operative to supply sixth output current to the output node.

In yet another example, the apparatus as discussed herein can be configured to include: multiple transformers including a first set of transformers and a second set of transformers, where each of the transformers in the first set is disposed in series in the first circuit path; and where each of the transformers in the second set is disposed in series in the second circuit path. The first set of transformers can be configured to provide magnetic coupling between the first power converter circuitry and the first circuit path; the second set of transformers can be configured to provide magnetic coupling between the second power converter circuitry and the second circuit path. The multiple transformers of the apparatus may further include a third set of transformers disposed in series in the third circuit path, where the third set of transformers operative to provide magnetic coupling between: i) the third circuit path and the first circuit path, and ii) the third circuit path and the second circuit path.

According to another example, the apparatus as discussed herein may include: a first power input node operative to supply first power to a first node of the first circuit path; a second power input node operative to supply second power to a first node of the second circuit path; and a third power input node operative to supply third power to a first node of the third circuit path.

Further examples as discussed herein include one or more methods of fabrication. In one example, a method as discussed herein includes a fabricator or other suitable entity: providing magnetic coupling of first power converter circuitry to a first circuit path; providing magnetic coupling of second power converter circuitry to a second circuit path; and providing magnetic coupling of each of the first circuit path and the second circuit path to a third circuit path.

The fabrication method may further include a fabricator or other suitable entity: providing magnetic coupling of third power converter circuitry to a fourth circuit path; providing magnetic coupling of fourth power converter circuitry to a fifth circuit path; providing magnetic coupling of each of the fourth circuit path and the fifth circuit path to a sixth circuit path; providing magnetic coupling between the third circuit path and a seventh circuit path; and providing magnetic coupling between the sixth circuit path and the seventh circuit path.

Further examples as discussed herein include one or more methods of operating a respective power converter. In one example, a method as discussed herein includes a controller or control circuitry: controlling operation of first power converter circuitry to produce first output current, the first power converter circuitry magnetically coupled to a first circuit path; controlling operation of second power converter circuitry to produce second output current, the second power converter circuitry magnetically coupled to a second circuit path, wherein both the first circuit path and the second circuit path are magnetically coupled to a third circuit path; and producing an output voltage via at least the first output current and the second output current.

These and other more specific concepts are discussed in more detail below.

As further discussed herein, techniques herein are well suited for use in the field of power supplies and power converters. However, it should be noted that this disclosure is not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion herein (BRIEF DESCRIPTION) purposefully does not specify every implementation and/or incrementally novel aspect of the present disclosure or claimed invention(s). Instead, this brief description only presents general implementations and corresponding points of novelty over conventional techniques. For additional details and/or possible perspectives (permutations) of the invention(s), the reader is directed to the Detailed Description section (which is a summary of possible implementation and operations) and corresponding figures of the present disclosure as further discussed below.

### BRIEF DESCRIPTION OF THE DRAWINGS

FIG. 1 is an example general diagram of a multi-tier (a.k.a., multilevel) trans-inductance power converter as discussed herein.

FIGS. 2A, 2B, and 2C, combine to form a multi-tier trans-inductance voltage regulator as discussed herein.

FIG. 3 is an example diagram illustrating a transformer model associated with a respective power converter as discussed herein.

FIGS. 4A, 4B, 4C, 4D, 4E, and 4F, combine to form a multi-tier trans-inductance voltage regulator as discussed herein.

FIGS. 5A and 5B combine to form a multi-tier trans-inductance voltage regulator as discussed herein.

FIG. 6 is an example timing diagram illustrating signals associated with operation of a multi-tiered power converter to convert an input voltage into an output voltage as discussed herein.

FIG. 7 is an example timing diagram illustrating signals associated with operation of a multi-tiered power converter to convert an input voltage into an output voltage as discussed herein.

FIGS. 8A and 8B combine to form a multi-tier trans-inductance voltage regulator as discussed herein.

FIG. 9 is an example timing diagram illustrating signals associated with operation of a multi-tiered power converter to convert an input voltage into an output voltage as discussed herein.

FIGS. 10A and 10B combine as an example implementation of a multi-tiered power converter as discussed herein.

FIG. 11 is an example diagram illustrating a method of fabricating a multi-tiered power converter as discussed herein.

FIG. 12 is an example diagram illustrating a method of controlling a multi-tiered power converter as discussed herein.

The foregoing and other objects, features, and advantages of the invention will be apparent from the following more particular description of preferred implementations herein, as illustrated in the accompanying drawings in which like reference characters refer to the same parts throughout the different views. The drawings are not necessarily to scale, with emphasis instead being placed upon illustrating the implementations, operations, principles, concepts, etc.

### DETAILED DESCRIPTION

In general, as discussed herein, a multi-tiered power converter can be configured to include first power converter circuitry and second power converter circuitry. The first power converter circuitry may be magnetically coupled to a first circuit path. The second power converter circuitry may be magnetically coupled to a second circuit path. The multi-tiered power converter further can be configured to include a third circuit path. Each of the first circuit path and the second circuit path may be magnetically coupled to the third circuit path to support conversion of at least one input voltage into at least one output voltage.

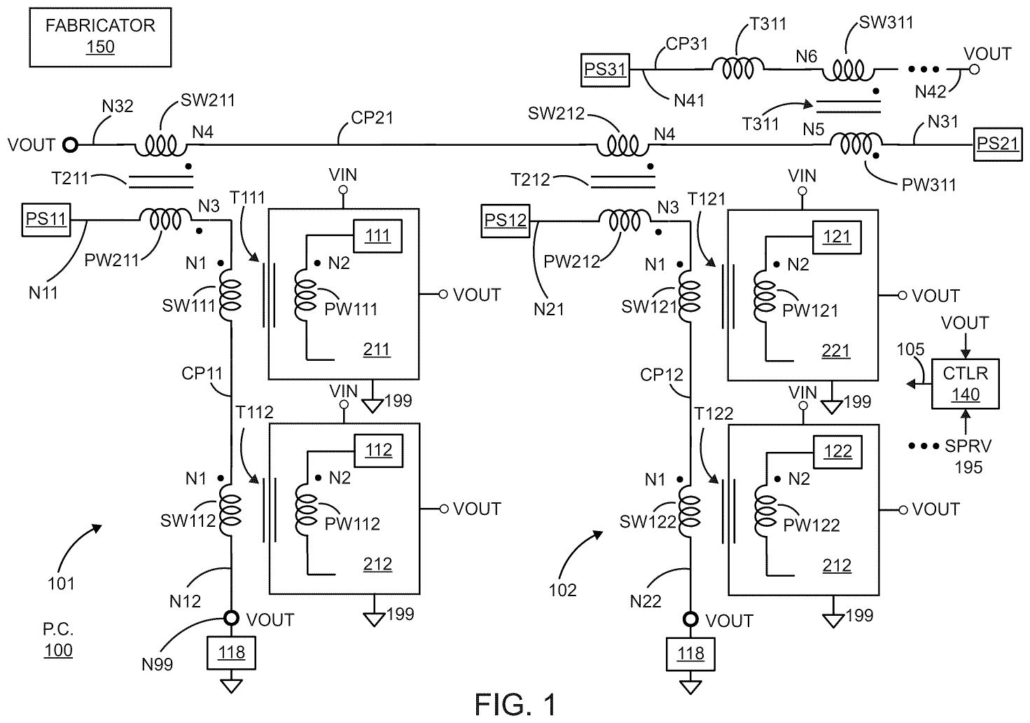

Now, more specifically, FIG. 1 is an example general diagram of a multi-tier power converter in accordance with a hierarchy of magnetic coupling as discussed herein.

In this example, the power converter 100 includes power converter circuitry 101, power converter circuitry 102, etc., at level 1 connectivity.

The power converter circuitry 101 includes multiple power converters (a.k.a., voltage regulators or other suitable entities) such as power converter 211, power converter 212, etc. The power converter circuitry 102 includes multiple power converters (a.k.a., voltage regulators for the single entities) such as power converter 221, power converter 222, etc.

Each power converter in the power converter 100 is magnetically coupled to a respective circuit path via a transformer.

For example, the power converter 100 includes transformer T111, transformer T 112, . . . , transformer T 121, transformer T 122, . . . , transformer T 211, transformer T 212, . . . , transformer T 311; and so on.

Transformer T 111 includes primary winding PW 111 magnetically coupled to the secondary winding SW 111; transformer T 112 includes primary winding PW 112 magnetically coupled to the secondary winding SW 112; and so on.

The transformer winding T 121 includes the primary winding PW 121 magnetically coupled to the secondary winding SW 121; the transformer T 122 includes the primary winding PW 122 magnetically coupled to the secondary winding a SW 122; and so on.

The transformer T 211 includes the primary winding PW 211 magnetically coupled to the secondary winding SW 211; the transformer T 212 includes the primary winding PW 212 magnetically coupled to the secondary winding SW 212; and so on.

The transformer T 311 includes the primary winding PW 311 magnetically coupled to the secondary winding SW 311; and so on.

Power converter 211 includes switch circuitry 111 (one or more switches such as a high side switch in the low side switch) to control a magnitude of current from the input voltage Vin through the primary winding PW 111 and outputted from the output node Vout of the power converter 211; power converter 212 includes switch circuitry 112 (one or more switches such as a high side switch in the low side switch) to control a magnitude of current from the input voltage Vin through the primary winding PW 112 and outputted from the output node Vout of the power converter 212; and so on.

Power converter 221 includes switch circuitry 121 (one or more switches such as a high side switch in the low side switch) to control a magnitude of current from the input voltage Vin through the primary winding PW 121 and outputted from the output node Vout of the power converter 221; power converter 222 includes switch circuitry 122 (one or more switches such as a high side switch in the low side switch) to control a magnitude of current from the input voltage Vin through the primary winding PW 122 and outputted from the output node Vout of the power converter 222; and so on.

Each of the secondary windings associated with a combination of the power converter 211, power converter 212, etc., is disposed in the circuit path CP 11. The circuit path CP 11 further includes the primary winding PW 211 connected in series with the secondary winding SW 111 and secondary winding SW 112.

The power converter 100 shown in FIG. 1 further includes one or more power sources such as power source PS 11, power source PS 12, power source PS 21, power source PS 31, etc., supplying power the current.

Power supply PS 11 provides power (input voltage) to a first node N11 (input node) of the circuit path CP 11; a second node N12 (output node) of the circuit path CP 11 produces and outputs the output voltage Vout to the load 118.

Accordingly, a combination of the primary winding PW 211, secondary winding SW 111, secondary winding SW 112, etc., is disposed in series between the input node N11 such as power supply PS 11 supplying the input power and the output node N12 supplying the output voltage Vout to the load 118.

Power supply PS 12 provides power (such as input voltage) to a first node N21 (input node) of the circuit path CP 12; a second node N22 (output node) of the circuit path CP 12 produces and outputs the output voltage Vout to power the load 118. Accordingly, a combination of the primary winding PW 212, secondary winding SW 121, secondary winding SW 122, etc., is disposed in series between the input node N21 such as power supply PS 12 supplying the input power and the output node N22 supplying the output voltage Vout to the load 118.

Note that the input voltage supplied by the power supply PS 11 and the input voltage supplied by the power supply PS 12 may be the same or different voltages.

Note that the output voltage nodes of each of the circuit paths of the power converter 100 can be electrically connected together at a single output node N99 of the power converter 100 to supply the corresponding output voltage Vout to the load 118.

As further shown, the circuit path CP 21 includes multiple windings disposed in series including primary winding PW 311, secondary winding SW 212, secondary winding SW 211, etc. The power supply PS 21 supplies input voltage (output current) to node N31 of the circuit path CP 21; while the output node N32 of the circuit path CP 21 outputs the output voltage Vout to the load 118 or other suitable entity.

It is further noted that the circuit path CP 31 includes one or more windings disposed in series between the power supply PS 31 and the output node producing the output voltage V out. More specifically, in this example, the circuit path CP 31 includes the secondary winding SW 311 disposed in series between the input node N41 of the power supply PS 31 supplying a respective input voltage to the circuit path CP 31 and the output node N42 producing the output voltage Vout.

It is noted again that each of the nodes N12, N22, N32, and N42 can be electrically connected to each other via one or more electrically conductive paths.

As further shown, the power converter 100 includes the controller 140, which produces the respective control signals 105 to control operation of the switch circuitry. More specifically, the control signals 105 control operation of the switch circuitry (switch circuitry 111, switch circuitry 112, . . . , switch circuitry 121, switch circuitry 122, . . . , etc.) associated with the power converters in the power converter 100 to convert the one or more input voltages provided by power supplies PS 11, PS 12, PS 21, and PS 31, etc., into the output voltage Vout.

In one example, the controller 140 monitors a magnitude of the output voltage Vout and compares it to a respective setpoint reference voltage 195 to produce an error voltage that is then used to adjust the control signals 105 accordingly. That is, based on the difference between the magnitude of the output voltage Vout with respect to the setpoint reference voltage 195, and corresponding generated error signal, the controller 140 (control circuitry) can be configured to control the magnitude of the output voltage Vout via modifications of the control signals 105 such that the magnitude of the output voltage Vout is substantially equal to a magnitude of the setpoint reference voltage 195.

Accordingly, the first power converter circuitry 101 includes power converter 211, power converter 212, etc., magnetically coupled to a first circuit path CP 11; the second power converter circuitry 102 includes power converter 221, power converter 222, etc., magnetically coupled to a second circuit path 102; and the power converter 100 includes a third circuit path CP 21, wherein each of the first circuit path CP 11 and the second circuit path CP 21 are magnetically coupled to the third circuit path CP 31 via respective transformer winding T 211 and transformer T 212. In other words, the first circuit path CP 11 includes primary winding PW 211 which magnetically couples the circuit path CP 11 to the circuit path CP 21. The second circuit path CP 12 includes primary winding PW 212 which magnetically couples the circuit path CP 12 to the circuit path CP 21.

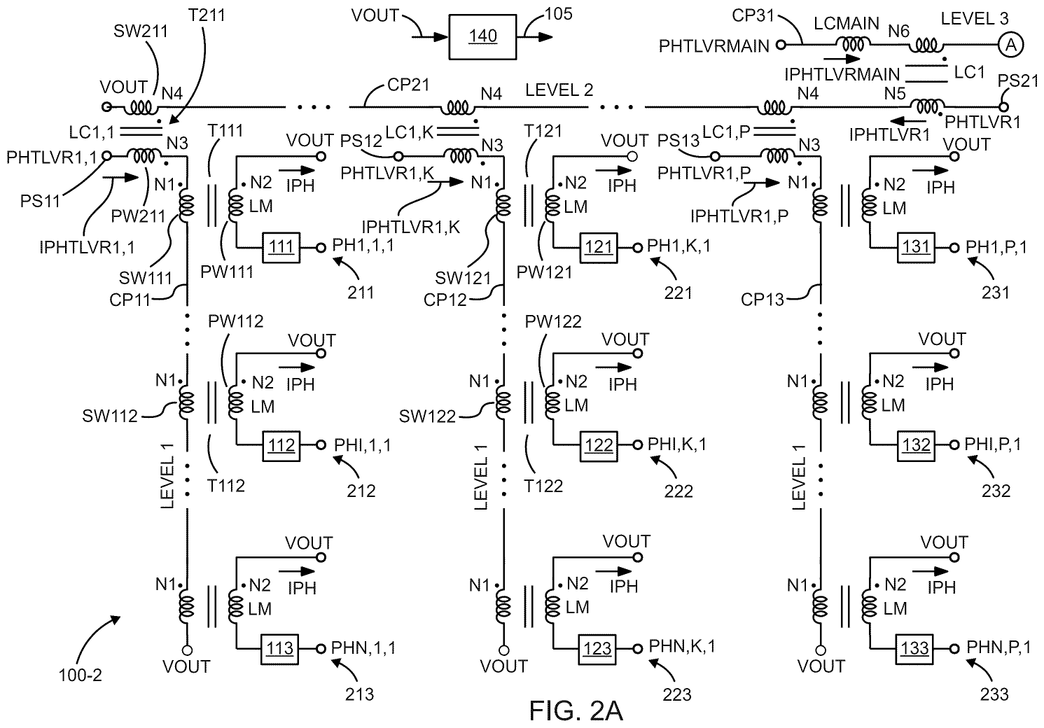

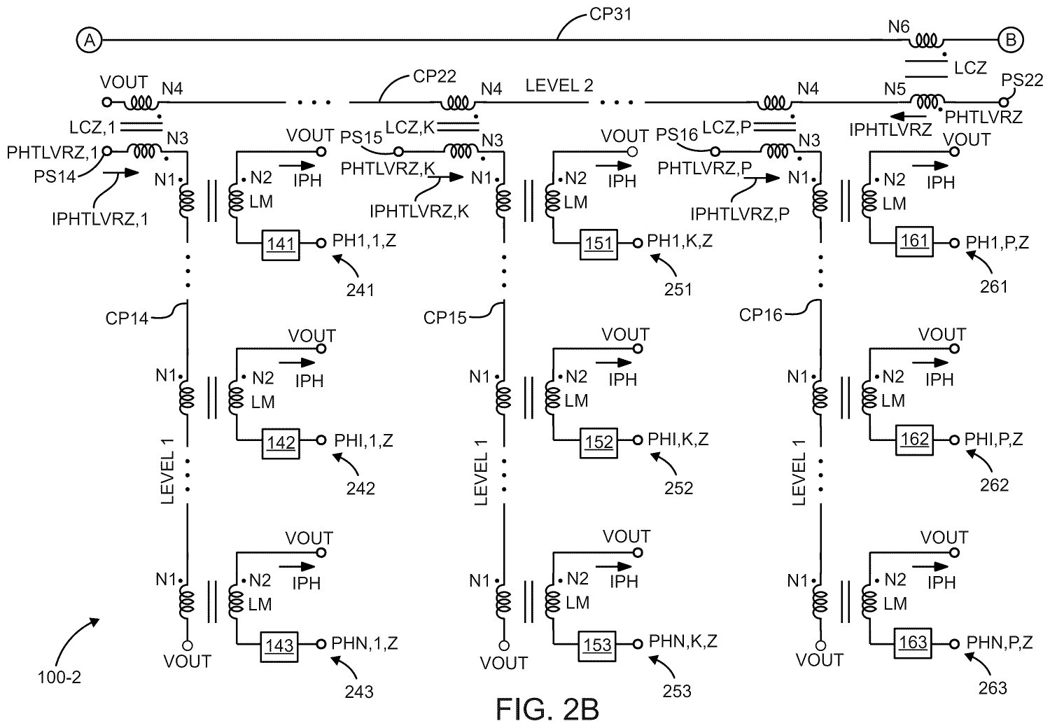

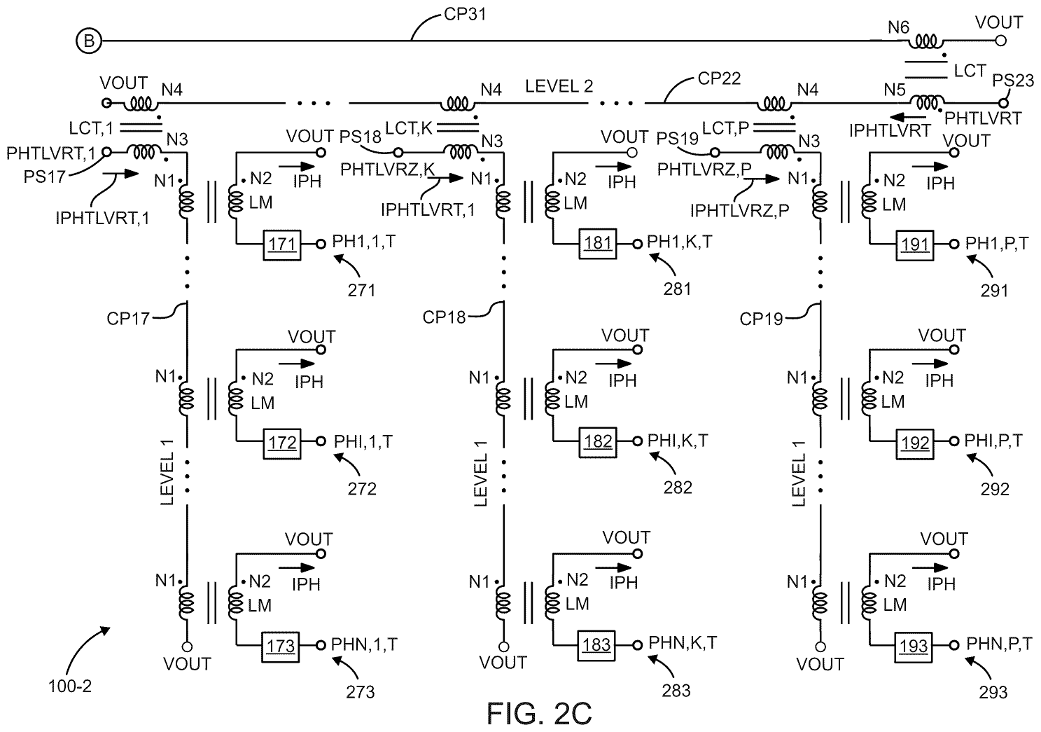

FIGS. 2A, 2B, and 2C, combine to form a multi-tier trans-inductance voltage regulator as discussed herein.

The multi-tiered trans-inductance voltage regulator such as the power converter 100-2 as shown in FIGS. 2A, 2B, and 2C includes 3 levels. However note that the multi-tier trans-inductance voltage regulator can include any number of cascaded levels of magnetically coupled circuit paths.

The techniques as discussed herein include one or more the following blocks:
On a first level (LEVEL 1) of the power converter 100-2, we refer to the zero-bias TLVR concepts having N elementary transformers with their primary windings LM being series-connected between ph_{i,k,z} (i.e. controlled by a switching network) and a common output voltage Vₒᵤₜ. The switching network of switches controlled by the controller 140 controls a magnitude of current through a respective winding Lₘ to ensure equal current sharing amongst the power converters, with each inductor Lₘ delivering the substantially same amount of DC current Iₚₕ (if for example the winding ratio equals n₁=n₂ for all elementary transformers).
Each of the windings L_{c}_{_{z,k}} (inductors) can be electrically coupled to a common “TLVR line” (a.k.a., series communication path) denominated as “TLVR line level 2” or LEVEL 2 (i.e., all n₄ windings connected in series in a respective circuit path between the output voltage node and the input node PHTLVRZ), which is terminated on one side with an inductor L_{c}_{_{z}} and on the other side is connected to a common output voltage Vₒᵤₜ. Note that the inductor L_{c}_{_{z}} and corresponding current therethrough may be controlled by a switching network of switches in in the respective power converter such way that, in steady state, the respective inductor delivers a DC current to the common output voltage

$${V}_{out} of {i}_{p {h}_{T L V {R}_{z}}} = \frac{{I}_{p h} {n}_{2} {n}_{3}}{{n}_{1} {n}_{4}} .$$

As further shown, each L_{c}_{_{z}} inductor may be electrically coupled to a common “main TLVR line” or LEVEL 3 denominated as “TL VR line level 3” (i.e. all n₆ windings connected in series) terminated on one side with an inductor L_{c}_{ₘₐᵢₙ} and on the other side is connected to a common output voltage Vₒᵤₜ. In one example, the inductor L_{c}_{ₘₐᵢₙ} and corresponding current therethrough is controlled by the switching network in such way that, in steady state, the respective inductor delivers a DC current to the output voltage

$${V}_{out} of {i}_{p {h}_{T L V {R}_{m a i n}}} = \frac{{I}_{p h} {n}_{2} {n}_{3} {n}_{5}}{{n}_{1} {n}_{4} {n}_{6}} .$$

This “main TLVR line”, for the sake of magnetic displacement can be also connected between two common quiet potentials (i.e. ground of the power converter).

In a similar manner as previously discussed, each of the circuit paths CP 11, CP 12, CP 13, . . . . CP 18, CP 19, produces a respective output voltage Vₒᵤₜ based on the controller 140 controlling operation of the respective switches of the power converters magnetically coupled to the respective circuit path.

Each of the circuit paths is magnetically coupled to the circuit path CP 21 via a respective transformer and winding is shown in FIGS. 2A-2C.

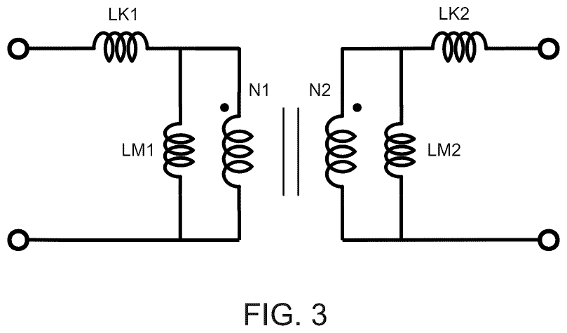

FIG. 3 is an example diagram illustrating a transformer associated with a respective power converter as discussed herein.

As previously discussed, a Cascaded TLVR such as the power converter 100-2 or other power converters as discussed herein may include multiple transformers connected as shown in FIGS. 2A, B, C, D, where each transformer can be described by a model, describing the transformer by a given coupling k between primary and secondary windings, and a magnetizing inductance Lₘ. FIG. 3 illustrates an equivalent circuit, which results in the following equations:

$${L}_{m 1} = {k}_{1 , 2} {L}_{1} \qquad ( 1 )$$

$${L}_{k 1} = ( 1 - {k}_{1 , 2} ) {L}_{1} \qquad ( 2 )$$

$${L}_{m 2} = {k}_{1 , 2} {L}_{2} \qquad ( 3 )$$

$${L}_{k 2} = ( 1 - {k}_{1 , 2} ) {L}_{2} \qquad ( 4 )$$

The turns ratio of the transformer has the following relation, with kₚₛ₁>0:

$$\frac{{L}_{m 1}}{{L}_{m 2}} = {( \frac{{n}_{1}}{{n}_{2}} )}^{2} \qquad ( 5 )$$

A second perspective of the cascaded trans-inductance voltage regulator or power converter 100-2 shown in FIGS. 2A, 2B, 2C in other FIGS. Is that the circuit is a cascaded electrically coupled inductor network including multiple different levels of TLVR lines. For example:
Level 1 (one or more circuit paths such as circuit path CP 11, CP 12, CP 13, etc.) includes multiple transformers with primary windings having n₁ turns and being connected in series and being terminated on one side at the output voltage Vₒᵤₜ and on the other end with an inductor L_{c}_{_{z,k}} being controlled by a switching network. Each multiple transformer has a secondary winding with n₂ turns, being connected on one side to a switching network and on the other side to an output voltage Vₒᵤₜ.
Level 2 (one or more circuit paths such as circuit path CP 21, CP 22, CP 23, etc.) includes one or multiple transformers wherein the primary windings having n₃ turns are connected in series to the primary winding turns n₁ of the “TLVR Level 1”. Each multiple transformer on Level 2 has their secondary windings, having n₄ turns, connected in series. This circuit is terminated on one side to the output voltage Vₒᵤₜ and on the other side with an inductor L_{c}_{_{z}} controlled by a switching network.
Level 3 (one or more circuit paths CP 31, etc.) includes one or multiple transformers wherein the primary windings having ng turns, are connected in series to the primary windings of the “Level 2” Cascaded TLVR. Each multiple transformer on their secondary windings with ne turns are connected in series terminated on one side with output voltage Vₒᵤₜ and on the other side with an inductor L_{c}_{ₘₐᵢₙ} controlled by a switching network.

The proposed architecture can be implemented with any level higher than 1, where the last level (highest level) can always be realized with either both terminations tied to quiet potentials (such as ground reference 199) or alternatively being terminated between an active switch network and a common output voltage Vₒᵤₜ.

A third perspective to describe the Cascaded TLVR shown in FIGS. 2A, 2B, 2C includes several elementary transformers displaced at any levels (i.e. more than one). Each elementary transformer has an equivalent model summarized through equations, from where it is evident that each phase node ph_{i,k,z} generates an induced voltage to the “TLVR line level 1”. This voltage is then reflected through L_{c}_{_{z,k}} to a “TLVR line level 2” by means of an elementary transformer identified by L_{c}_{_{z,k}}. On the TLVR line level 2 the summation of the voltages over L_{c}_{_{z,k}} is reflected to the “TL VR line level 3” at the secondary side of the elementary transformer identified by L_{c}_{_{z}}. Finally, on the TLVR line level 3 the summation of the voltages Le is seen by the main transient inductor called L_{c}_{ₘₐᵢₙ}.

A fourth perspective to describe the Cascaded TLVR (power converter) shown in FIGS. 2A, 2B, 2C is as follows: a novel magnetic architecture which includes several cascaded TLVR levels wherein each level includes a switching network and elementary transformers coupled to a higher level and an elementary transformers coupled to a lower level. The last highest TLVR level (i.e. can be extended to any levels) might have either a switching network and/or a physical inductor L_{c}_{ₘₐᵢₙ} or is alternatively connected between common quiet potentials (i.e. power converter reference ground).

A fifth perspective to describe the Cascaded TLVR shown in FIGS. 2A, 2B, 2C and other FIGS. as discussed herein includes several cascaded TLVR levels wherein starting from the last level (i.e. Level 3) considering the cascaded TLVR structure of FIGS. 2A, 2B, 2C a variation of the current, caused by a coupled voltage on L_{c}_{ₘₐᵢₙ}, is reflected through the elementary transformer L_{c}_{_{z}} to the level below (i.e. Level 2 considering the structure shown in FIGS. 2A, 2B, 2C. The same mechanism applies to any level below, cascading down to the inductors Lₘ connected between the switching network on ph_{i,k,z} and common output voltage Vₒᵤₜ. This is useful since any variation of the current at L_{c}_{ₘₐᵢₙ} level is reflected to any level below. Hence the transient response of the circuit can be significantly improved.

A last perspective to describe the Cascaded TLVR shown in FIGS. 2A, 2B, 2C and other FIGS. as discussed herein includes several cascaded TLVR levels wherein starting from the last level (i.e. Level 3 considering cascaded TLVR structure of FIGS. 2A, 2B, 2C a switching network controls the current on L_{c}_{ₘₐᵢₙ} in such a way that all elementary transformers L_{c}_{_{z}} have zero DC bias magnetic flux in their transformers. Again the same mechanism may apply to any level below cascading down to the inductors Lₘ connected between the switching network on ph_{i,k,z} and common output voltage Vₒᵤₜ.

Inductor Based Topology Using Different Input Voltages and/or Switching Frequencies

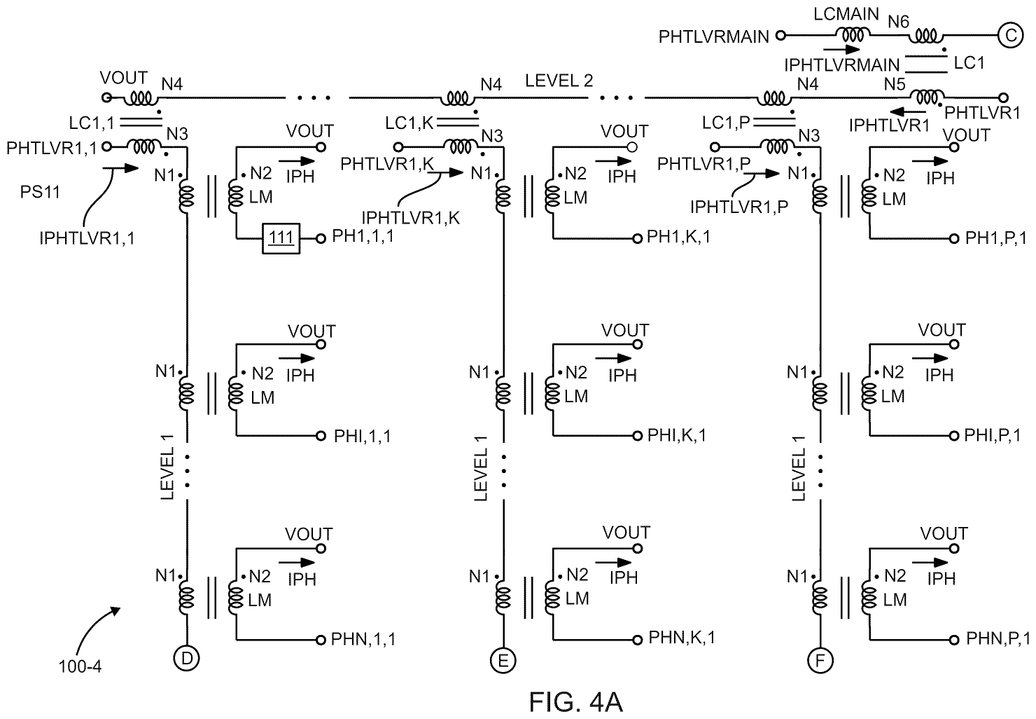

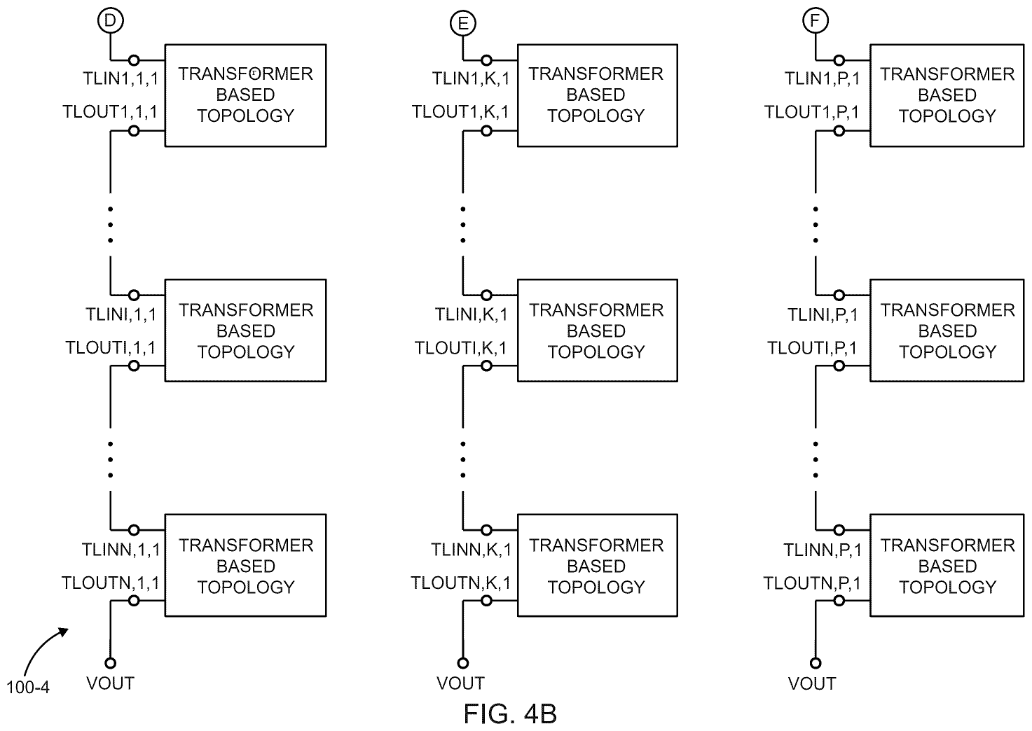

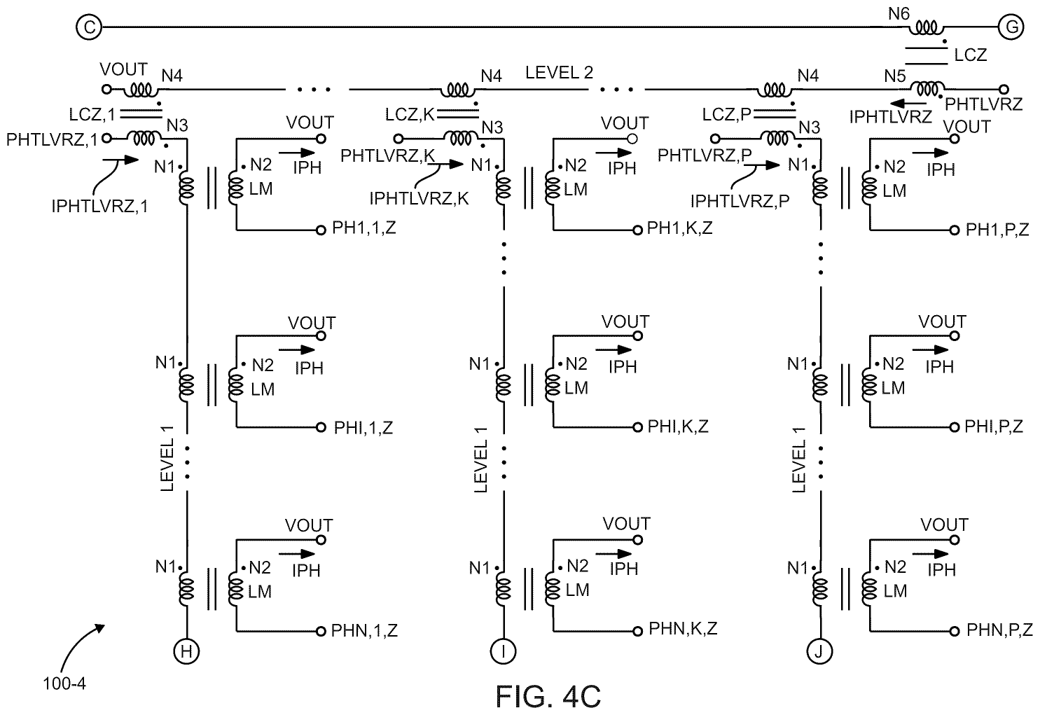

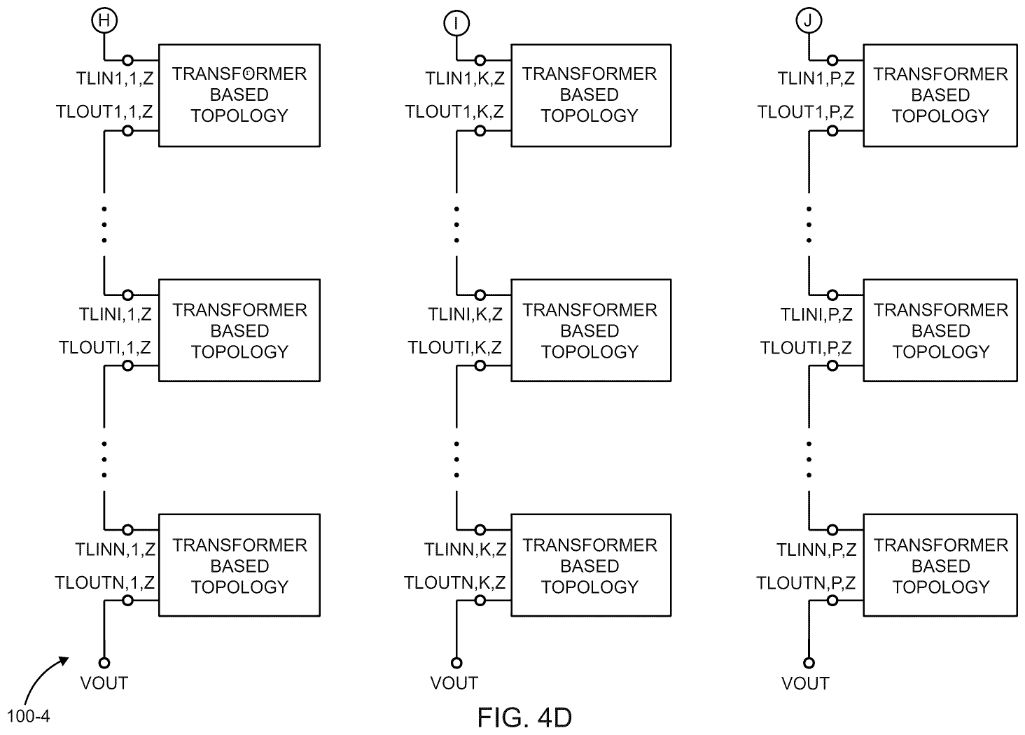

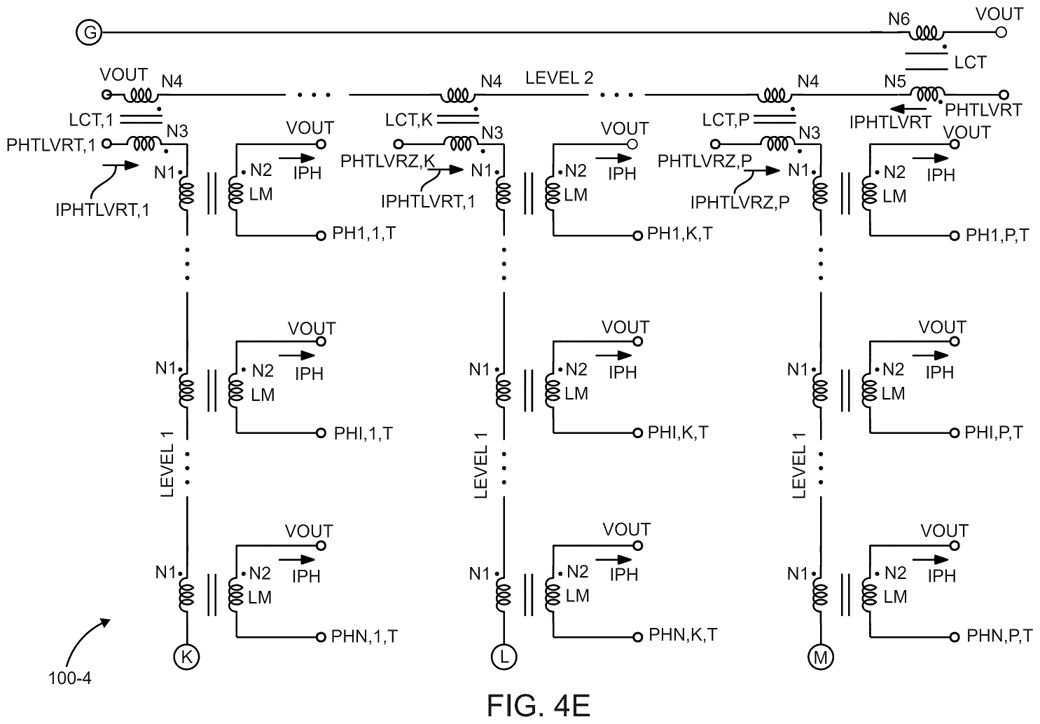

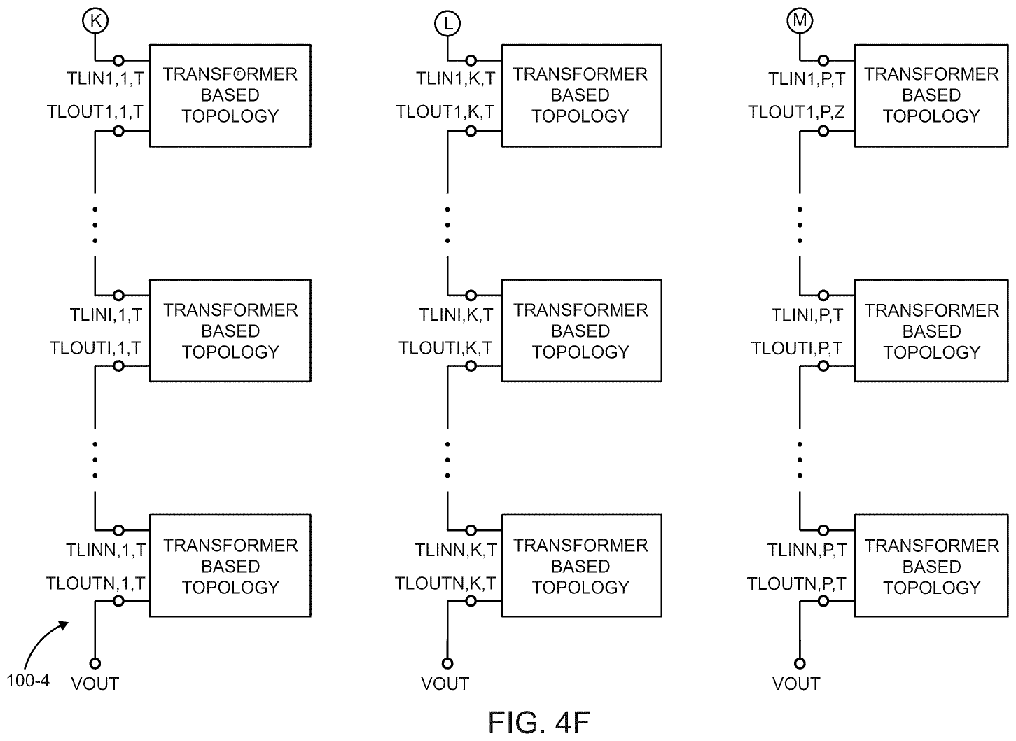

As previously discussed, examples herein include a novel architecture for electrically coupled inductors according to FIGS. 2A, 2B, 2C or other FIGS., which may in a second example be implemented with switching networks (connected to ph_{i,k,z}) having different input voltages and/or being controlled at different frequencies. Thus, one of the main advantages of the proposed cascaded TLVR approach is its scalability. In this sub-section an example is given considering a new building block formed by a transformer-based topology. The electric coupling is realized on Level 1 through TLᵢₙ_{_{i,k,z}} and TLₒᵤₜ_{_{i,k,z}} as shown in FIGS. 4A-4F, which is a generalized Cascaded TLVR with 3 levels extended to a hybrid implementation (i.e. having transformer-based and non-transformer-based elements).

Now, more specifically, FIGS. 4A, 4B, 4C, 4D, 4E, and 4F, combine to form a multi-tier trans-inductance voltage regulator as discussed herein.

One example of the proposed cascaded TLVR structure as discussed herein can be implemented with a classic buck converter (i.e. each ph_{i,k,z}, ph_{TLVR}_{_{z,k}}, ph_{TLVR}_{_{z}} connected to a half-bridge between input voltage Vin and ground potential GND). The magnetic structure can be built with any magnetic shapes and materials, wherein each magnetic element connected to ph_{i,k,z} can be also magnetically coupled (i.e. inverse magnetic coupling between ph_{i,k,z}, ph_{i+1,k,z}, ph_{i+2,k,z}, ph_{i+u,k,z} where u is the amount of phases magnetically coupled within the same core) at the same sub-level (i.e. magnetic coupling can be considered also for any level). In this section a few examples are provided including a possible hybrid implementation having a so-called current-doubler based rectifier.

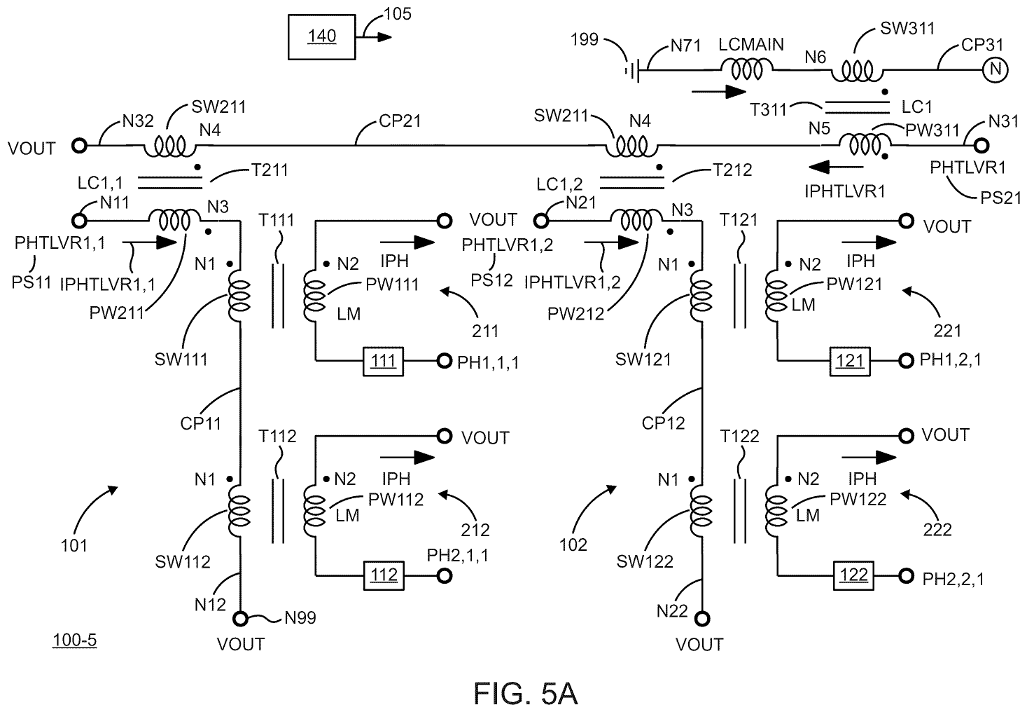

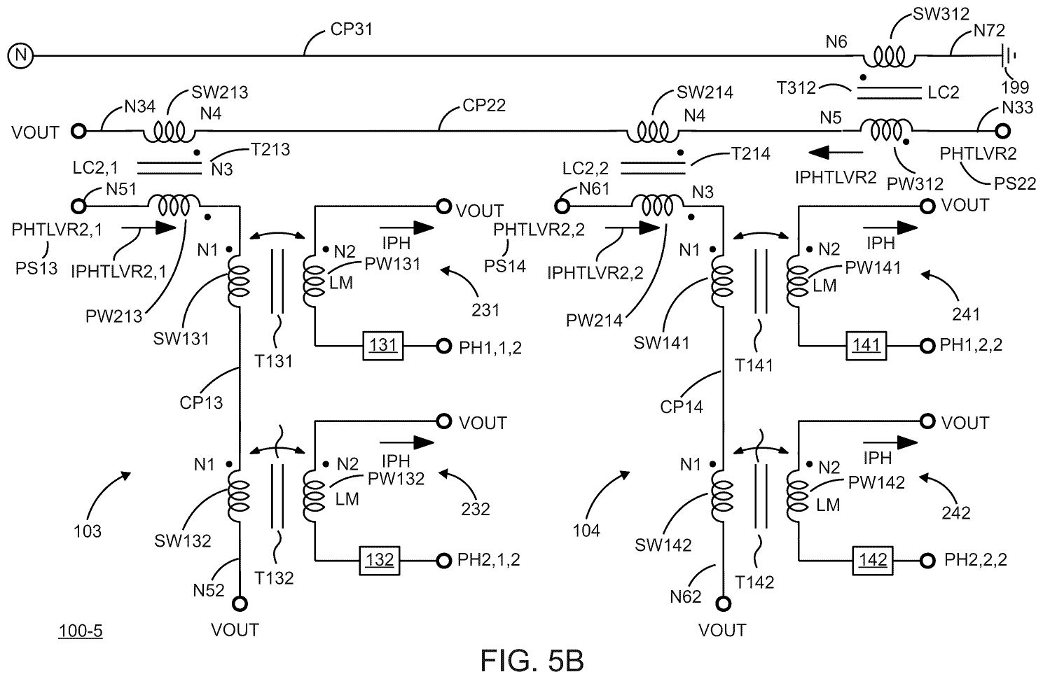

FIGS. 5A and 5B combine to form a multi-tier trans-inductance voltage regulator as discussed herein.

For example, FIGS. 5A and 5B illustrate a proposed cascaded TLVR with one single magnetic core and the output voltage being powered by the third level with i=2, k=2, z=2 and n₁=n₂=n₃=n₄=n₅=n₆ wherein:
two buck converters are connected to a common output voltage Vₒᵤₜ, where each converter is delivering the same DC current Iₚₕ.
   Both phases are electrically coupled to a common TLVR line (i.e. all connected in series) which is terminated on one side with an inductor L_{c}_{_{z,k}} inductor being controlled by a half-bridge and on the other side being terminated to a common output voltage Vₒᵤₜ. The inductor L_{c}_{_{z,k}} is controlled by a half-bridge in such a way that in steady state it is delivering a DC current to the output voltage Vₒᵤₜ of Iₚₕ.
Each L_{c}_{_{z,k}} inductors are then electrically coupled to a common TLVR line (i.e. all n₁ windings connected in series), which is terminated on one side with an inductor L_{c}_{_{z}} and on the other side being connected to a common output voltage Vₒᵤₜ. The inductor L_{c}_{_{z}} is controlled by a half-bridge in such a way that in steady state it is delivering a DC current to the output voltage Vₒᵤₜ of Iₚₕ.
Each L_{c}_{_{z}} inductors are then electrically coupled to a common “main” TL VR line (i.e. all n₄ windings connected in series) which is terminated on one side with an inductor L_{c}_{ₘₐᵢₙ} and on the other side being connected to a common output voltage Vₒᵤₜ. The inductor L_{c}_{ₘₐᵢₙ} is controlled by a buck converter in such a way that in steady state it is delivering a DC current to the output voltage Vₒᵤₜ of Iₚₕ.

In this example, the power converter 100-5 includes the circuitry and connectivity as previously discussed in FIG. 1.

As further shown, the power converter 100-5 in FIGS. 5A-5B includes power converter circuitry 103 and power converter circuitry 104.

The power converter circuitry 103 includes multiple power converters (a.k.a., voltage regulators or other suitable entities) such as power converter 231, power converter 232, etc. The power converter circuitry 104 includes multiple power converters (a.k.a., voltage regulators for the single entities) such as power converter 241, power converter 242, etc.

Each power converter in the power converter 100-5 is magnetically coupled to a respective circuit path via a transformer.

For example, the power converter 100-5 includes transformer T 131, transformer T 132, . . . , transformer T 141, transformer T 142, . . . , transformer T 213, transformer T 214, . . . , transformer T 312; and so on.

Transformer T 131 includes primary winding PW 131 magnetically coupled to the secondary winding SW 131; transformer T 132 includes primary winding PW 132 magnetically coupled to the secondary winding SW 132; and so on.

The transformer winding T 141 includes the primary winding PW 141 magnetically coupled to the secondary winding SW 141; the transformer T 142 includes the primary winding PW 142 magnetically coupled to the secondary winding a SW 142; and so on.

The transformer T 213 includes the primary winding PW 213 magnetically coupled to the secondary winding SW 213; the transformer T 214 includes the primary winding PW 214 magnetically coupled to the secondary winding SW 214; and so on.

The transformer T 312 includes the primary winding PW 312 magnetically coupled to the secondary winding SW 312; and so on.

Power converter 231 includes switch circuitry 131 (one or more switches such as a high side switch in the low side switch) to control a magnitude of current from the input voltage Vin through the primary winding PW 131 and outputted from the output node Vₒᵤₜ of the power converter 231; power converter 232 includes switch circuitry 132 (one or more switches such as a high side switch in the low side switch) to control a magnitude of current from the input voltage Vin through the primary winding PW 132 and outputted from the output node Vₒᵤₜ of the power converter 232; and so on.

Power converter 241 includes switch circuitry 141 (one or more switches such as a high side switch in the low side switch) to control a magnitude of current from the input voltage Vin through the primary winding PW 141 and outputted from the output node Vₒᵤₜ of the power converter 241; power converter 242 includes switch circuitry 142 (one or more switches such as a high side switch in the low side switch) to control a magnitude of current from the input voltage Vin through the primary winding PW 142 and outputted from the output node Vₒᵤₜ of the power converter 242; and so on.

Each of the secondary windings associated with a combination of the power converter 231, power converter 232, etc., is disposed in the circuit path CP 13. The circuit path CP 13 further includes the primary winding PW 213 connected in series with the secondary winding SW 131 and secondary winding SW 132.

The power converter 100-5 further includes one or more power sources such as power source PHTLVR1 (PS 21) at node N31 and power source PHTLVR2 at node N33, etc., supplying power or current.

The power converter 100-5 further includes one or more power sources such as power source PHTLVR1,1 (such as power source PS 11) at node N11 and power source PHTLVR1,2 (such as power source PS 12) at node N21, etc., supplying power or current.

The power converter 100-5 further includes one or more power sources such as power source PHTLVR2, 1 at node N51 of the circuit path CP 13 and power source PHTLVR2,2 at node N52 of the circuit path CP 14, etc., supplying power or current.

Power supply PS 11 or PHTLVR1,1 provides power (input voltage) to a first node N11 (input node) of the circuit path CP 11; a second node N12 (output node) of the circuit path CP 11 produces and outputs the output voltage Vout to the load 118.

Accordingly, a combination of the primary winding PW 211, secondary winding SW 111, secondary winding SW 112, etc., is disposed in series in the circuit path CP 11 between the input node N11 such as power supply PS 11 supplying the input power and the output node N12 supplying the output voltage Vout to the load 118.

A combination of the primary winding PW 212, secondary winding SW 121, secondary winding SW 122, etc., is disposed in series in the circuit path CP 12 between the input node N21 such as power supply PS 12 supplying the input power and the output node N22 supplying the output voltage Vout to the load 118.

A combination of the primary winding PW 213, secondary winding SW 131, secondary winding SW 132, etc., is disposed in series in the circuit path CP 13 between the input node N51 such as power supply PS 13 supplying the input power and the output node N52 supplying the output voltage Vout to the load 118.

A combination of the primary winding PW 214, secondary winding SW 141, secondary winding SW 142, etc., is disposed in series in the circuit path CP 14 between the input node N61 such as power supply PS 14 supplying the input power and the output node N62 supplying the output voltage Vout to the load 118.

Note that the output voltage nodes of each of the circuit paths at level 1 and other levels of the power converter 100 can be electrically connected together at a single output node N99 of the power converter 100 to supply the corresponding output voltage Vout to the load 118.

As further shown, the circuit path CP 22 includes multiple windings disposed in series including primary winding PW 312, secondary winding SW 214, secondary winding SW 213, etc. The power supply at node N33 supplies input voltage (or current) to node N33 of the circuit path CP 22; while the output node N34 of the circuit path CP 22 outputs the output voltage Vout to the load 118 or other suitable entity.

At level 3, it is further noted that the circuit path CP 31 includes one or more windings disposed in series between the reference voltage 199. More specifically, in this example, the circuit path CP 31 includes the inductor LCMAIN, secondary winding SW 311 and secondary winding SW 312 disposed in series between the input node N71 of the of the circuit path CP 31 and the node N72 of the circuit path CP 31, where the node N71 and node N72 are connected to the ground reference voltage 199.

It is noted again that each of the nodes N12, N22, N32, and N42 can be electrically connected to each other via one or more electrically conductive paths.

In a manner as previously discussed, the power converter 100 includes the controller 140, which produces the respective control signals 105 to control operation of the switch circuitry. More specifically, the control signals 105 control operation of the switch circuitry (switch circuitry 111, switch circuitry 112, . . . , switch circuitry 121, switch circuitry 122, . . . , switch circuitry 131, switch circuitry 132, . . . , switch circuitry 141, switch circuitry 142 etc.) associated with the power converters in the power converter 100-5 to convert the one or more input voltages provided by a respective one or more power supplies PS 11, PS 12, PS 21, and PS 31, etc., into the output voltage Vout.

In one example, in a similar manner as previously discussed, the controller 140 monitors a magnitude of the output voltage Vout and compares it to a respective setpoint reference voltage 195 to produce an error voltage that is then used to adjust the control signals 105 accordingly. That is, based on the difference between the magnitude of the output voltage Vout with respect to the setpoint reference voltage 195, and corresponding generated error signal, the controller 140 (control circuitry) can be configured to control the magnitude of the output voltage Vout via modifications of the control signals 105 such that the magnitude of the output voltage Vout is substantially equal to a magnitude of the setpoint reference voltage 195.

Further in this example, note that DC bias cancellation can be achieved at all elementary transformers except the inductor L_{c}_{ₘₐᵢₙ} which is actually only an inductor. Hence the losses in the circuit are massively reduced.

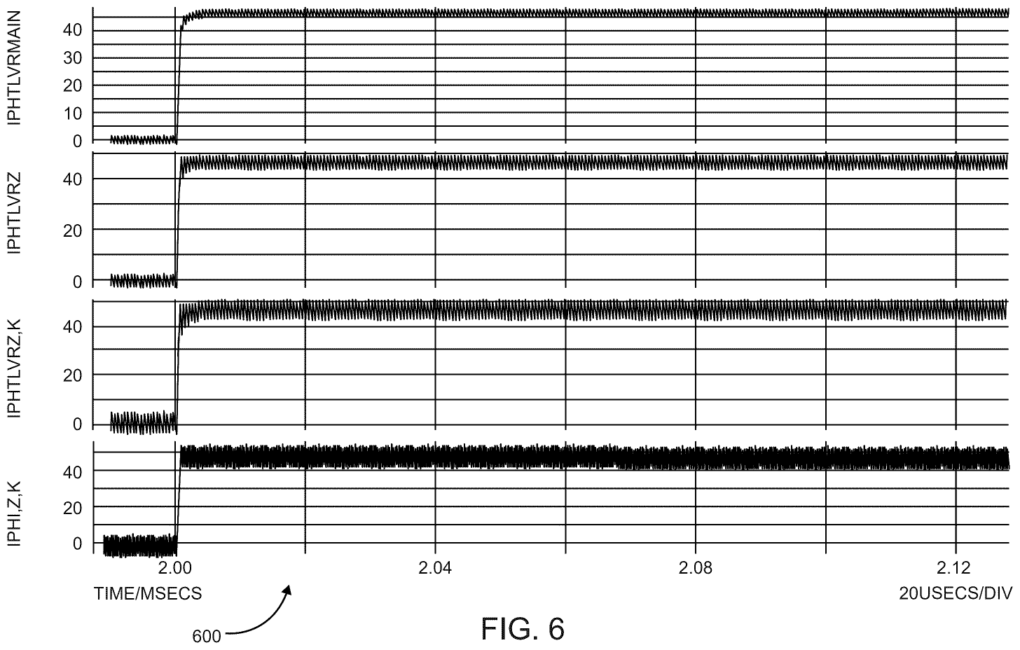

Accordingly, this example illustrates implementation of 3 levels having i=2, k=2, z=2 and a third level powering the output voltage. The waveforms associated with generation of the phase currents from each of the power converters is shown in FIG. 6.

FIG. 6 is an example timing diagram (graph 600) illustrating signals associated with operation of a multi-tiered power converter (as shown in FIGS. 5A and 5B) to convert an input voltage into an output voltage as discussed herein.

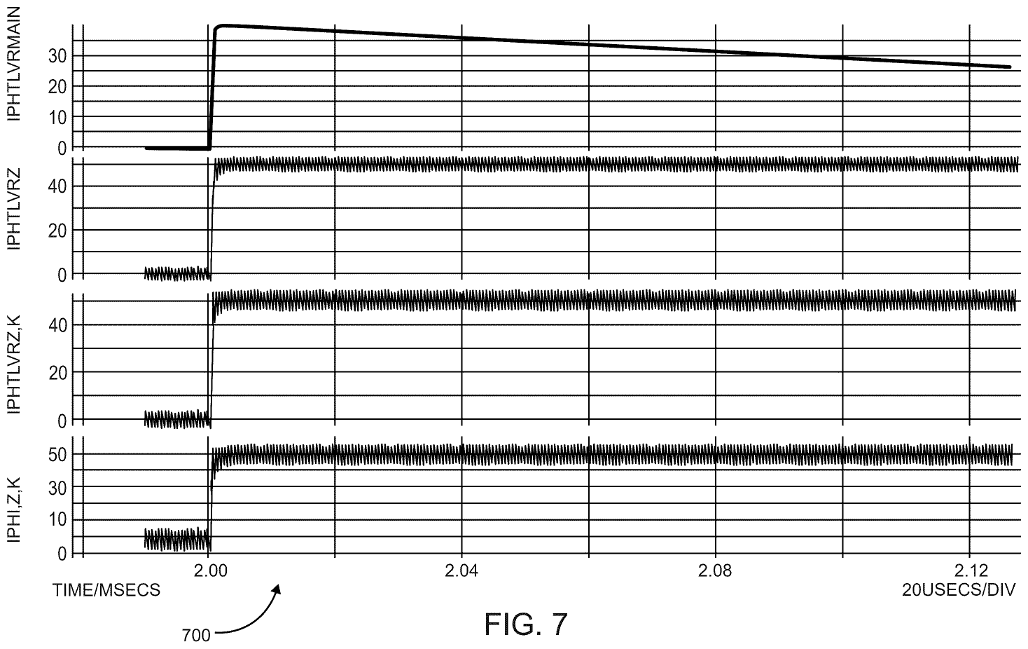

FIG. 7 is an example timing diagram illustrating signals associated with operation of a multi-tiered power converter to convert an input voltage into an output voltage as discussed herein.

In this example, assume that the power converter 100 as discussed herein such is a cascaded TLVR with one single magnetic core with i=2, k=2, z=2 with the third level not transferring actively energy to the load.

The timing diagrams (graph 700) in FIG. 7 illustrate phase currents associated with a cascaded TLVR architecture with i=2, k=2, z=2 and n₁=n₂=n₃=n₄=n₅=n₆, wherein the “main TLVR line” is connected between ground references. Therefore, L_{c}_{ₘₐᵢₙ} in steady state does not carry any DC current component.

In this example DC bias cancellation is achieved in all the elementary transformers except in the inductor L_{c}_{ₘₐᵢₙ}, L_{c}_{₁} and L_{c}_{₂}.

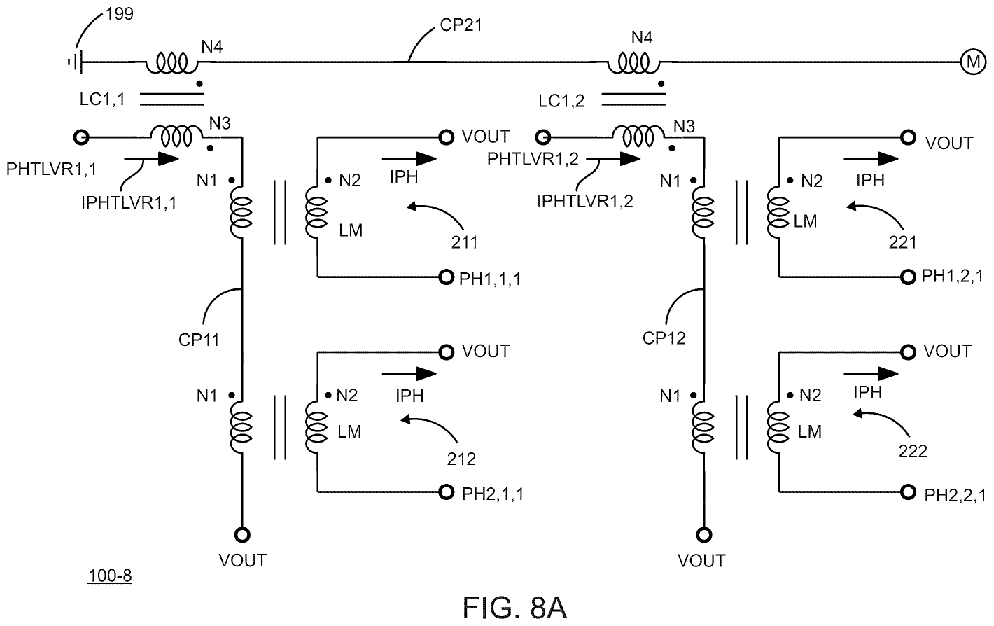

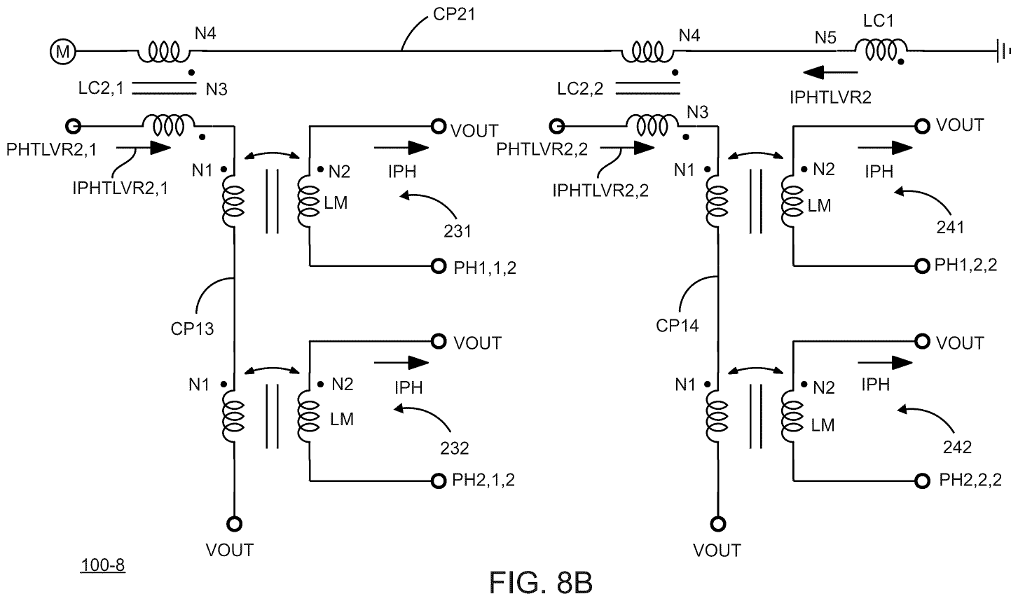

FIGS. 8A and 8B combine to form a multi-tier trans-inductance voltage regulator as discussed herein.

In this example, the node N91 of the circuit path CP 21 is connected to the ground reference 199; the node N92 of the circuit path CP 21 is connected to the ground reference 199.

The power converter 100-8 (such as a 2 level power converter) is a cascaded TLVR with one single magnetic core with i=2, k=2, z=2 and a second level, which does not transfer active energy to the load. Further in this example, the number of turns associated with the respective windings is n₁=n₂=n₃=n₄ wherein:
Two buck converters are connected to a common output voltage Vₒᵤₜ, where each converter is delivering the same DC current Iₚₕ.
   Both phases are electrically coupled to a common TLVR line (i.e. all n₁ windings connected in series) which is terminated on one side with an inductor L_{c}_{_{z,k}} inductor controlled by a half-bridge and on the other side being connected to a common output voltage Vₒᵤₜ. The inductor L_{c}_{_{z,k}} is controlled by a buck converter in a such way that in steady state it is delivering a DC current to the output voltage Vₒᵤₜ of Iₚₕ.
Each L_{c}_{_{z,k}} inductors are then electrically coupled to a common TLVR line with all n₄ windings connected in series with an inductor L_{c}_{_{z}}. The TLVR line is then terminated on both sides by a common quite potential ground GND.

In this example DC bias cancellation is achieved in all the elementary transformers except on the inductor L_{c}_{₁}, L_{c}_{_{1,1}}, L_{c}_{_{1,2}}, L_{c}_{_{2,1}} and L_{c}_{_{2,2}}.

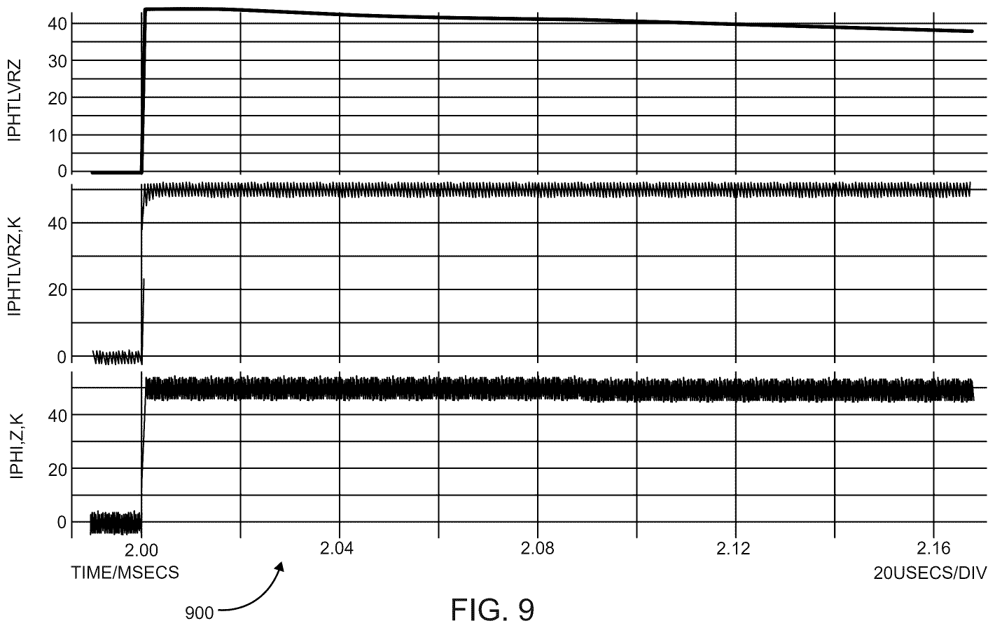

FIG. 9 is an example timing diagram illustrating singles associated with operation of a multi-tiered power converter to convert an input voltage into an output voltage as discussed herein.

Graph 900 of timing diagrams in FIG. 9 are associated with operation of a simplified example of the power converter 100-8 (i.e., without considering optimal power paths of two levels implementation having i=2, k=2, z=2 and a second level which does not transfer active energy to the load because terminal ends of the circuit path associated with the second level are connected to the same voltage potential such as a ground reference potential 199.

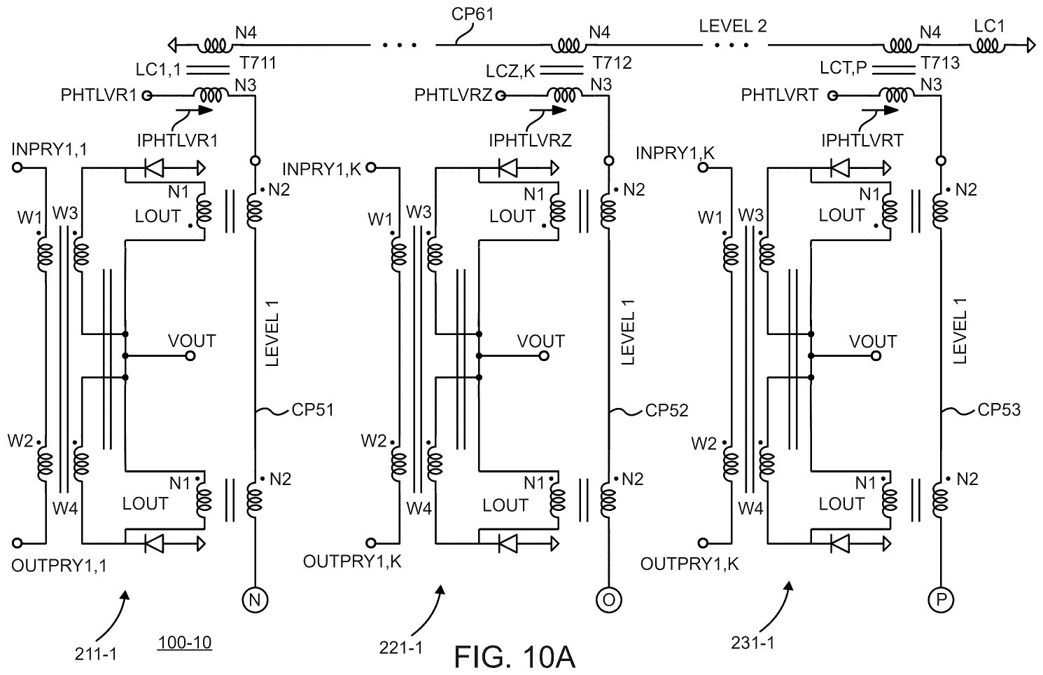

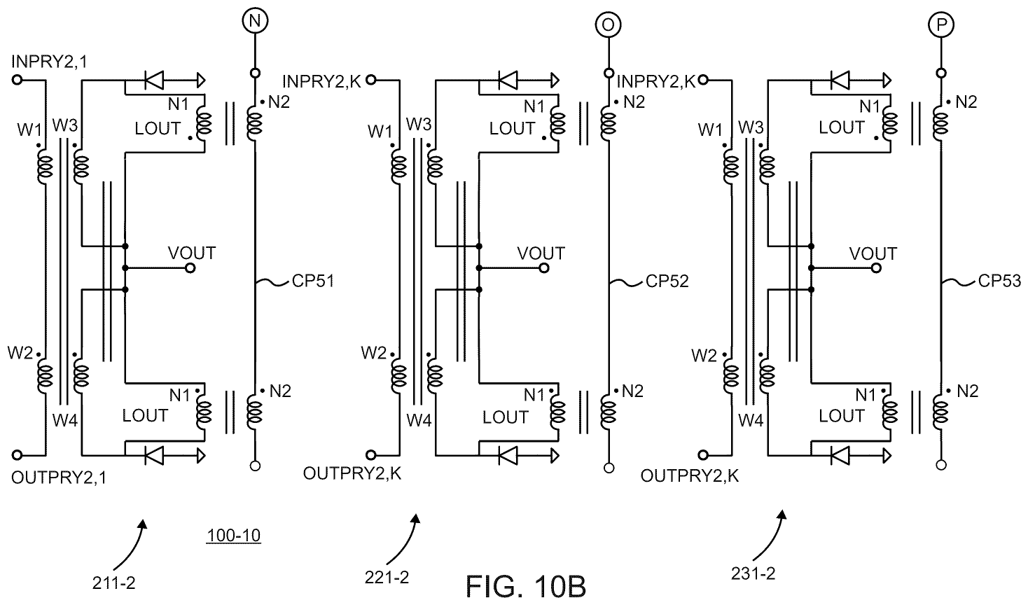

FIGS. 10A and 10B combine to form an example implementation of a multi-tiered power converter as discussed herein.

As shown, the power converter 100-10 can be implemented as a so-called current-doubler rectifier that is electrically coupled with multi-phase buck converter coupled in a cascaded multi-tiered TLVR configuration.

In this example, the power converter 100-10 includes power converter 211-1 and the power converter 211-2 magnetically coupled to the circuit path CP 51. Circuit path CP 51 further includes the transformer T 711, which magnetically couples the circuit path CP 51 to the circuit path CP 61.

The power converter 100-10 includes power converter 221-1 and the power converter 221-2 magnetically coupled to the circuit path CP 52. Circuit path CP 52 further includes the transformer T 712, which magnetically couples the circuit path CP 52 to the circuit path CP 61.

That power converter 100-10 includes power converter 231-1 and the power converter 231-2 magnetically coupled to the circuit path CP 53. Circuit path CP 53 further includes the transformer T 713, which magnetically couples the circuit path CP 53 to the circuit path CP 61.

Recall that the novel power converter 200 architecture as previously discussed in FIGS. 2A-2C may also be implemented with switching network connected to ph_{i,k,z} having different input voltage and/or switching network controlled by different frequencies. Thus, one of the main advantages of the proposed cascaded TLVR approaches as discussed herein is the scalability of such circuitry. That is, any # of individual voltage regulators can be connected in parallel at one or more different levels to produce an overall power converter architecture capable of providing appropriate output power to a load.

In this section, an example is given considering a new building block. A local high-density converter arranged in parallel (i.e. thanks to the zero-bias TLVR concept from TLVR level 1) while at TLVR level 2 classic TLVR electric coupling [1] can be implemented.

More specifically, as shown in the power converter 100-10 of FIGS. 10A and 10 B, can be configured based on a hybrid approach, having current doubler based topology (i.e. with any primary side structure) coupled with a buck based topology on TLVR level 1 (i.e., to cancel a DC flux within the current doubler inductors). As shown in in the power converter 1000, the proposed hybrid cascaded TLVR structure ensures local DC flux cancelation on the inductor forming the current doubler rectifier by properly controlling the current sharing between the current doubler based converter and the buck converter. Each L_{c}_{_{z,k}} inductors are then electrically coupled to a common TLVR line, all connected in series with an inductor L_{c}_{₁}, the TLVR line is then terminated on both sides with a common quiet potential ground GND reference.

Thus, as discussed herein, the different proposed TLVR architectures support high density (small volume of power converter circuitry providing high power output) and high transient capability DC-DC converter solutions.

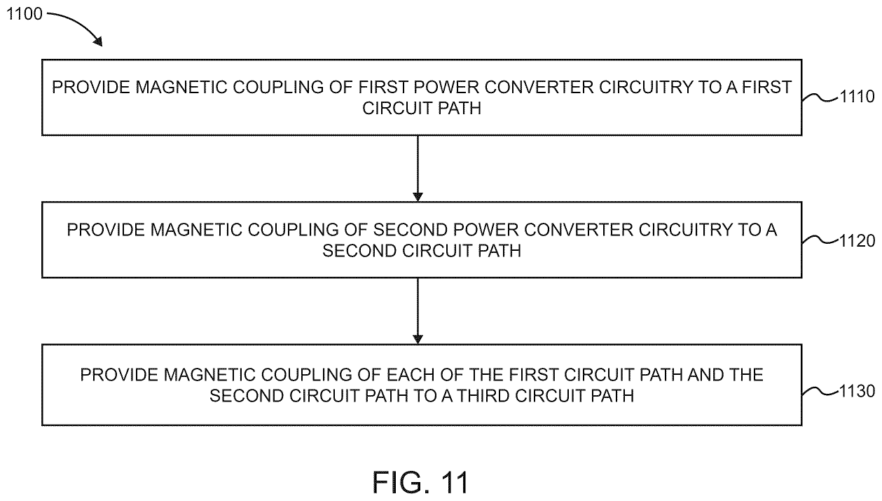

FIG. 11 is an example diagram illustrating a method of fabricating a multi-tiered power converter as discussed herein.

In processing operation 1110 in flowchart 1100, the fabricator 150 provides magnetic coupling of first power converter circuitry to a first circuit path.

In processing operation 1120, the fabricator 150 provides magnetic coupling of second power converter circuitry to a second circuit path.

In processing operation 1130, the fabricator 150 provides magnetic coupling of each of the first circuit path and the second circuit path to a third circuit path.

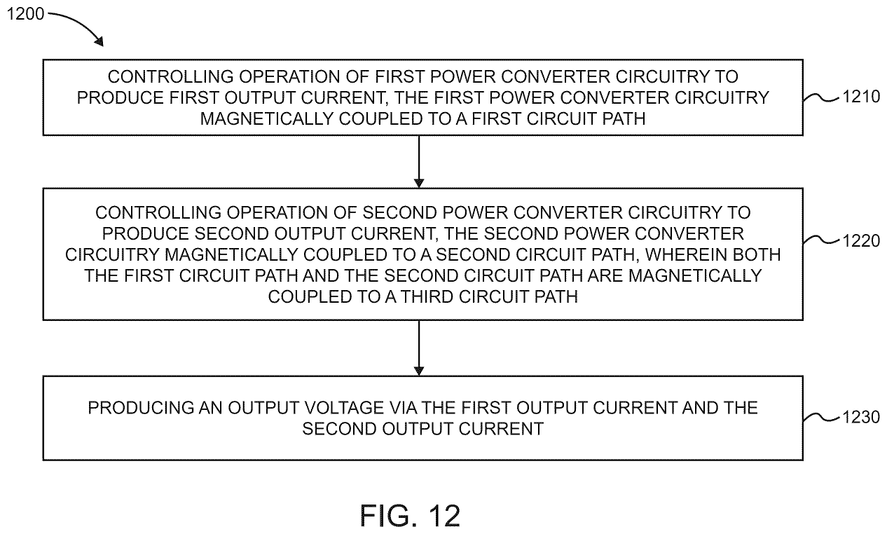

FIG. 12 is an example diagram illustrating a method of controlling a multi-tiered power converter as discussed herein.

In processing operation 1210 in flowchart 1200, the controller 140 controls operation of first power converter circuitry to produce first output current, the first power converter circuitry magnetically coupled to a first circuit path.

In processing operation 1220, the controller 140 controls operation of second power converter circuitry to produce second output current, the second power converter circuitry magnetically coupled to a second circuit path, wherein both the first circuit path and the second circuit path are magnetically coupled to a third circuit path.

In processing operation 1230, the controller 140 produces an output voltage via the first output current and the second output current.

Note again that techniques herein are well suited for use in power conversion and multilayer trans-inductance voltage regulator applications. However, it should be noted that the concepts in this disclosure are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

It will be understood by those skilled in the art that various changes in form and details may be made therein without departing from the spirit and scope of the present application as defined by the appended claims. Such variations are intended to be covered by the scope of this present application. As such, the foregoing description of the present application is not intended to be limiting. Rather, any limitations to the invention are presented in the following claims.

1. An apparatus comprising:
first power converter circuitry magnetically coupled to a first circuit path;
second power converter circuitry magnetically coupled to a second circuit path; and
a third circuit path, wherein each of the first circuit path and the second circuit path are magnetically coupled to the third circuit path.

2. The apparatus as in claim 1, wherein the first power converter circuitry includes a first winding, the first winding magnetically coupled to a second winding disposed in series in the first circuit path; and
wherein the second power converter circuitry includes a third winding, the third winding magnetically coupled to a fourth winding disposed in series in the second circuit path.

3. The apparatus as in claim 1, wherein the first power converter circuitry includes a first group of power converters, each of which is magnetically coupled to the first circuit path;
wherein the second power converter circuitry includes a second group of power converters, each of which is magnetically coupled to the second circuit path, the apparatus further comprising:
control circuitry operative to control balancing of output currents outputted from the power converters in the first group and the power converters in the second group to produce an output voltage.

4. The apparatus as in claim 1 further comprising:
a first power supply operative to supply first current to the first circuit path at a first terminal of the first circuit path; and
wherein a second terminal of the first circuit path is operative to output the first current to produce an output voltage;
a second power supply operative to supply second current to the second circuit path at a first terminal of the second circuit path; and
wherein a second terminal of the second circuit path is operative to output the second current to produce the output voltage.

5. The apparatus as in claim 1 further comprising:
a first transformer including a first winding magnetically coupled to a second winding, the first winding disposed in series in the first circuit path; and
a second transformer including a third winding magnetically coupled to a fourth winding, the third winding disposed in series in the second circuit path.

6. The apparatus as in claim 5, wherein the second winding is disposed in series with the fourth winding in the third circuit path.

7. The apparatus as in claim 1, wherein the first power converter circuitry and the second power converter circuitry operate in parallel to collectively produce an output voltage.

8. The apparatus as in claim 1 further comprising:
third power converter circuitry magnetically coupled to a fourth circuit path;
fourth power converter circuitry magnetically coupled to a fifth circuit path; and
a sixth circuit path, wherein each of the fourth circuit path and the fifth circuit path are magnetically coupled to the sixth circuit path.

9. The apparatus as in claim 8 further comprising:
a seventh circuit path;
wherein the third circuit path is magnetically coupled to the seventh circuit path, and
wherein the sixth circuit path is magnetically coupled to the seventh circuit path.

10. The apparatus as in claim 9 further comprising:
an output node operative to output an output voltage;
wherein each of the first power converter circuitry, the second power converter circuitry, the third power converter circuitry, and the fourth power converter circuitry collectively contribute to producing an output voltage; and
wherein each of the first circuit path, the second circuit path, the third circuit path, the fourth circuit path, the fifth circuit path, the sixth circuit path, and the seventh circuit path output respective output current to the output node to produce the output voltage.

11. The apparatus as in claim 1 further comprising:
an output node operative to output an output voltage collectively generated by the first power converter circuitry and the second power converter circuitry;
wherein each power converter in the first power converter circuitry includes a respective output terminal, the respective output terminals of the power converters in the first power converter circuitry operative to collectively supply first output current to the output node;
wherein each power converter in the second power converter circuitry includes a respective output terminal, the respective output terminals of the power converter as in the second power converter circuitry operative to collectively supply second output current to the output node.

12. The apparatus as in claim 11, wherein the first circuit path includes a terminal operative to supply third output current to the output node; and
wherein the second circuit path includes a terminal operative to supply fourth output current to the output node.

13. The apparatus as in claim 12, wherein the third circuit path includes a terminal operative to supply fifth output current to the output node.

14. The apparatus as in claim 13 further comprising:
a fourth circuit path magnetically coupled to the third circuit path.

15. The apparatus as in claim 14, wherein the fourth circuit path includes a terminal operative to supply sixth output current to the output node.

16. The apparatus as in claim 1 further comprising:
multiple transformers including a first set of transformers and a second set of transformers;
wherein each of the transformers in the first set is disposed in series in the first circuit path; and
wherein each of the transformers in the second set is disposed in series in the second circuit path.

17. The apparatus as in claim 16, wherein the first set of transformers is operative to provide magnetic coupling between the first power converter circuitry and the first circuit path; and
wherein the second set of transformers is operative to provide magnetic coupling between the second power converter circuitry and the second circuit path.

18-19. (canceled)

20. A method comprising:
providing magnetic coupling of first power converter circuitry to a first circuit path;
providing magnetic coupling of second power converter circuitry to a second circuit path; and
providing magnetic coupling of each of the first circuit path and the second circuit path to a third circuit path.

21. The method as in claim 20 further comprising:
providing magnetic coupling of third power converter circuitry to a fourth circuit path;
providing magnetic coupling of fourth power converter circuitry to a fifth circuit path;
providing magnetic coupling of each of the fourth circuit path and the fifth circuit path to a sixth circuit path;
providing magnetic coupling between the third circuit path and a seventh circuit path; and
providing magnetic coupling between the sixth circuit path and the seventh circuit path.

22. A method comprising:
controlling operation of first power converter circuitry to produce first output current, the first power converter circuitry magnetically coupled to a first circuit path;
controlling operation of second power converter circuitry to produce second output current, the second power converter circuitry magnetically coupled to a second circuit path, wherein both the first circuit path and the second circuit path are magnetically coupled to a third circuit path; and
producing an output voltage via the first output current and the second output current.
